(19) United States
(12) Patent Application Publication
(10) Pub. No.: US 2004/0172810 A1
(43) Pub. Date: Sep. 9, 2004

(54) Crimping unit for joining electric connectors to flat electric cables

(76) Inventor: Luigi Aluffo, Fubine (IT)

Correspondence Address: HARRINGTON & SMITH, LLP, 4 RESEARCH DRIVE, SHELTON, CT, 06484-6212, US

(21) Appl. No.: 10/474,554

(22) PCT Filed: Apr. 12, 2002
(86) PCT No.: PCT/EP02/04107

(30) Foreign Application Priority Data
Apr. 13, 2001 (IT) T001A000369

(51) Int. Cl. B23P 19/00

(52) U.S. Cl. 29/761; 29/753

(57) ABSTRACT

There is described a crimping unit for joining electric connectors (2) to flat electric cables (3). The unit (1) has an anvil assembly (24) defining a seat (32; 32a) for housing a casing (8) of a connector (2); a pressure assembly (26) cooperating with the anvil assembly (24) to crimp the terminals (4) of the connector (2) to respective conducting tracks (5) of a flat electric cable (3); and an ejector (69) having a first push rod (72) housed in the anvil assembly (24) to expel the casing (8) from the seat (32; 32a).

### TECHNICAL FIELD

The present invention relates to a crimping unit for joining electric connectors to flat electric cables.

### BACKGROUND ART

A flat electric cable comprises a strip of insulating material on which are arranged a number of parallel, side by side conducting tracks.

An electric connector comprises a casing made of insulating material; a number of electric terminals housed partly inside the casing; and a cover made of insulating material, associated with the casing, and movable between and open position and a closed position.

To join electric connectors to flat electric cables, each electric terminal is connected mechanically and electrically, i.e. crimped, to a relative conducting track, and the strip is gripped between the cover and casing.

The number of conducting tracks on flat electric cables and the number of electric terminals on electric connectors obviously vary depending on what the cables are used for.

At present, crimping units capable of joining electric connectors to flat electric cables and permitting a high production output rate with very few rejects do not exist.

### DISCLOSURE OF INVENTION

It is an object of the present invention to provide a crimping unit for joining electric connectors to flat electric cables, and which permits a high production output rate.

According to the present invention, there is provided a crimping unit for joining electric connectors to flat electric cables, as claimed in claim 1.

### BRIEF DESCRIPTION OF THE DRAWINGS

A non-limiting embodiment of the present invention will be described by way of example with reference to the accompanying drawings, in which:

FIG. 1 shows a view in perspective, with parts removed for clarity, of a crimping unit for crimping electric connectors to flat electric cables in accordance with the present invention;

FIG. 2 shows a view in perspective, with parts removed for clarity, of an assembly comprising an electric connector and a flat electric cable;

FIG. 2a shows a larger-scale detail of the FIG. 2 connector;

FIG. 3 shows a larger-scale vertical section of the FIG. 1 crimping unit;

FIG. 4 shows a larger-scale section, with parts removed for clarity, of a detail in FIG. 3;

FIG. 5 shows a section along line V-V in FIG. 4, with parts removed for clarity;

FIG. 6 shows a larger-scale view in perspective of a component part of the FIGS. 4 and 5 detail;

FIG. 7 shows a larger-scale section, with parts removed for clarity, along line VII-VII in FIG. 3;

FIGS. 8 and 9 show larger-scale views in perspective, with parts removed for clarity, of two details of the crimping unit;

FIG. 10 shows a section of a portion of the crimping unit equipped to join electric connectors to small-size flat electric cables.

### BEST MODE FOR CARRYING OUT THE INVENTION

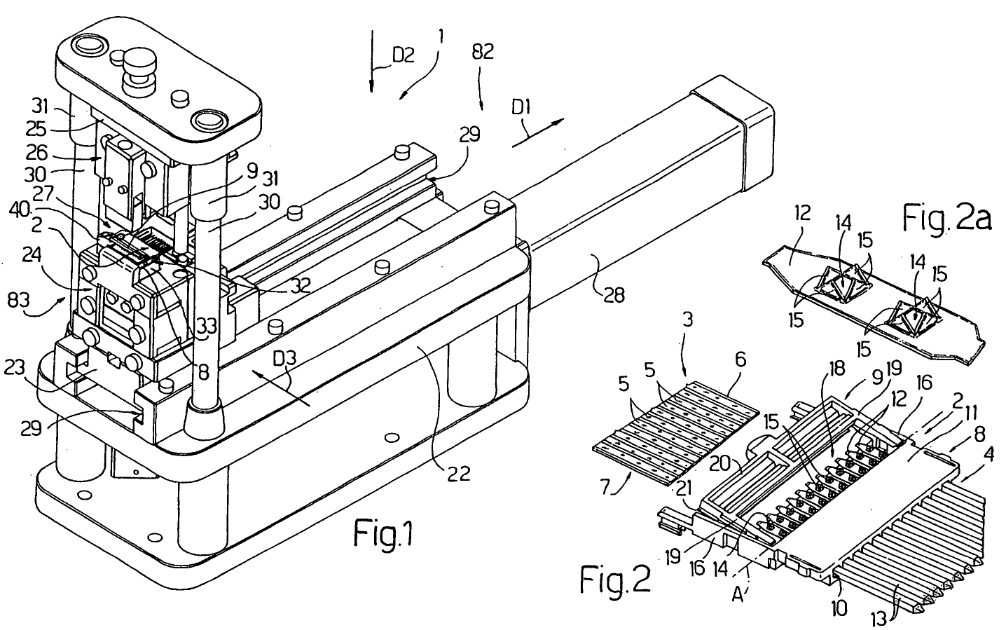

With reference to FIGS. 1 and 2, number 1 indicates as a whole a crimping unit for joining electric connectors 2 to flat electric cables 3, and connecting electric terminals 4 of connectors 2 to respective conducting tracks 5 of cables 3. Each connector 2 comprises a conducting portion defined by electric terminals 4, and cable 3 comprises a conducting portion defined by tracks 5. With reference to FIG. 2, each flat electric cable 3 comprises a strip 6 of insulating material supporting a number of parallel conducting tracks 5; each track 5 is located a given distance from the adjacent track 5 so as to be electrically insulated from it; the number of conducting tracks 5 on each cable 3 varies depending on end-use requirements; and the number of electric terminals 4 on connector 2 equals the number of tracks 5 on relative cable 3. Consequently, the transverse dimensions of strips 6 and connectors 2 vary according to the number of tracks 5 and the number of electric terminals 4 respectively. In the present description, numbers 2 and 3 respectively indicate connectors and cables of different transverse dimensions.

For simplicity, the end portion of cable 3 for connection to relative connector 2 will be referred to hereinafter as “end portion” 7.

Connector 2 comprises a flat insulating casing 8, and a cover 9 hinged to casing 8. Casing 8 comprises a main body 10, in which is formed a row of parallel, side by side seats 11 for housing a number of electric terminals 4 equal to the number of conducting tracks 5 on relative cable 3. Each electric terminal 4 comprises a connecting blade 12 which is crimped to a relative conducting track 5 on cable 3; and a connecting pin 13 which is inserted inside a complementary terminal (not shown). Though male terminals 4 are shown in FIG. 2, the same characteristics also apply to female terminals (not shown), which differ from terminals 4 by having seats in place of pins 13.

Each blade 12 has two holes 14, each of which is surrounded by pointed tabs 15 extending perpendicularly to blade 12 and formed by cross-cutting blade 12 and then bending the tabs squarely with respect to blade 12. The bent tabs 15 are substantially triangular, provide for piercing strip 6 and track 5, and are folded onto end portion 7 and outwards of hole 14 to electrically and mechanically connect, i.e. crimp, blade 12 to a respective track 5.

Casing 8 has two lateral arms 16 extending from main body 10; and a crosspiece 17 connecting arms 16 to form a window 18 partly occupied by blades 12.

Cover 9 is substantially C-shaped, is hinged to arms 16 about an axis A perpendicular to arms 16, and comprises two levers 19 parallel to arms 16 and supporting a crosspiece 20 parallel to crosspiece 17. Levers 19 have two projections 21, which fit inside respective seats (not shown) on arms 16 to click cover 9 shut with respect to casing 8 in a position (not shown) in which crosspieces 17 and 20 grip cable 3.

In the open position shown in FIG. 2, cover 9 slopes with respect to arms 16, so that end portion 7 of cable 3 can be inserted between crosspieces 17 and 20 to position conducting tracks 5 directly on top of respective blades 12.

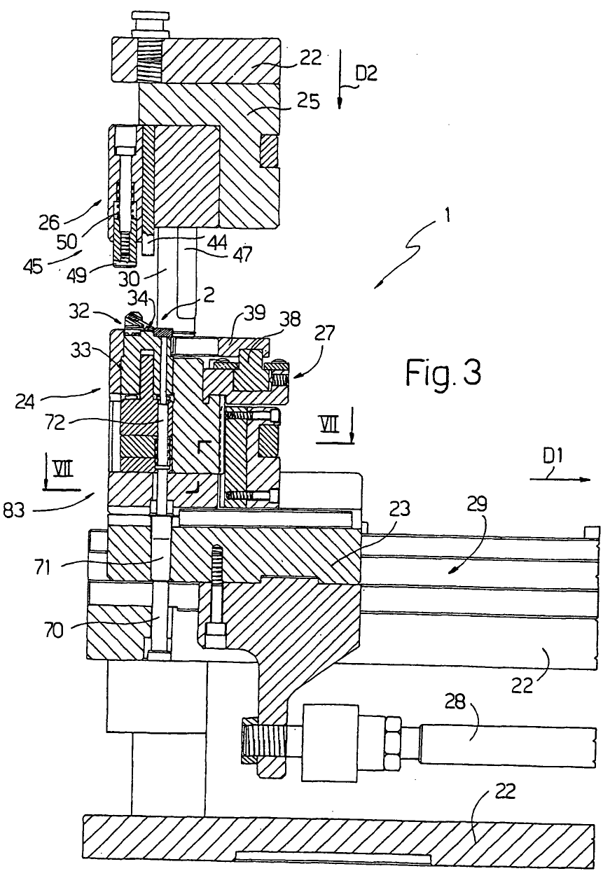

With reference to FIGS. 1 and 3, crimping unit 1 comprises a supporting frame 22; a slide 23 movable with respect to frame 22 in a horizontal direction D1; an anvil assembly 24 on slide 23; a slide 25 movable to and from anvil assembly 24 in a vertical direction D2; a pressure assembly 26 fitted to slide 25 and which cooperates with anvil assembly 24; a control device 27 for controlling the position of cover 9: a drive member 28 for moving slide 23 back and forth in direction D1; and a drive member (not shown) for moving slide 25 up and down in direction D2. Frame 22 comprises two horizontal grooves 29, which are engaged prismatically by slide 23 to guide slide 23 in direction D1; and two vertical columns 30, each of which engages a sleeve 31 of slide 25 to guide slide 25 in direction D2. Anvil assembly 24 is fitted to the top of slide 23, has a seat 32 for housing connector 2, and supports device 27.

With reference to FIG. 3, anvil assembly 24 comprises an anvil 33 defining seat 32 at the top and having a number of projections 34 for supporting respective blades 12 of a relative connector 2.

Projections 34 are parallel and equally spaced in a direction D3 perpendicular to directions D1 and D2, and provide for centering window 18 to define a given position of connector 2 on anvil 33. In other words, anvil 33 is specially designed for a connector 2 of given shape and size, and can be replaced with other anvils for connectors 2 of different shapes and sizes.

Device 27 is fitted to anvil assembly 24, is movable with respect to anvil assembly 24 in direction D3, and comprises a central body 38 fitted prismatically to anvil assembly 24, and an arm 39 projecting, parallel to direction D1, from body 38 and having, on its free end, a head 40 with a seat 41 for housing one of levers 19 of cover 9. Body 38 is movable with respect to anvil assembly 24 between an operating position (FIG. 3) in which cover 9 engages seat 41 in head 40, and a release position releasing cover 9.

Pressure assembly 26 comprises a member 44 for deforming tabs 15 on blades 12; a pusher 45 for closing cover 9 with respect to casing 8; a vertical rod (not shown) having a tapered free end, and which cooperates with device 27, as pressure assembly 26 moves towards anvil assembly 24, to move device 27 and head 40 from the operating to the release position; and two vertical rods 47 which engage two guide holes 48 formed in anvil assembly 24. Pusher 45 comprises a head 49, which is positioned along crosspiece 20, is connected prismatically to pressure assembly 26 to slide in direction D2, and is kept in the down position by a spring 50.

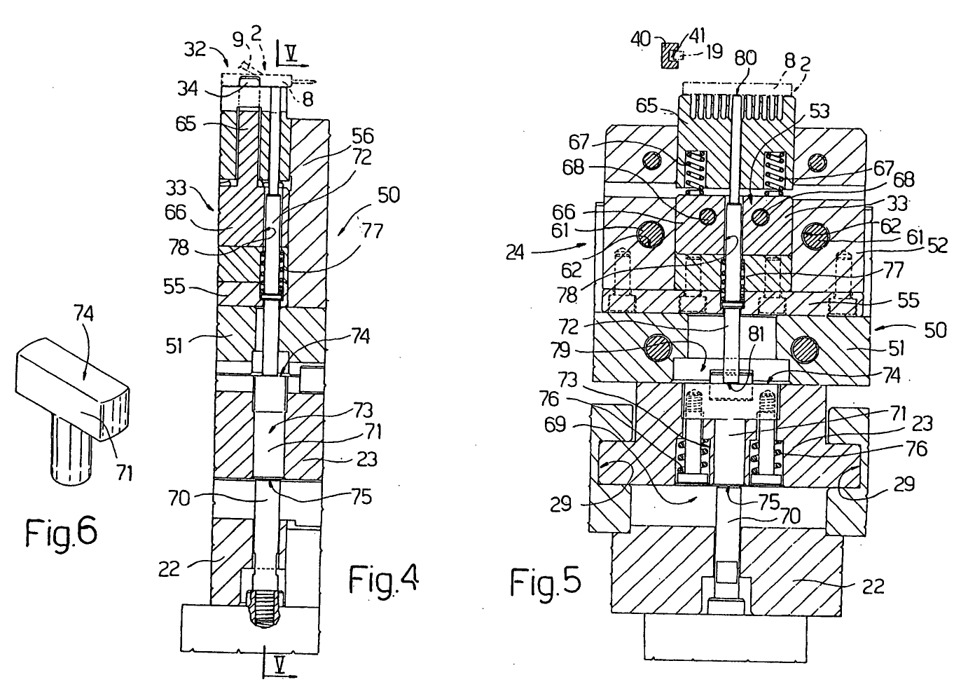

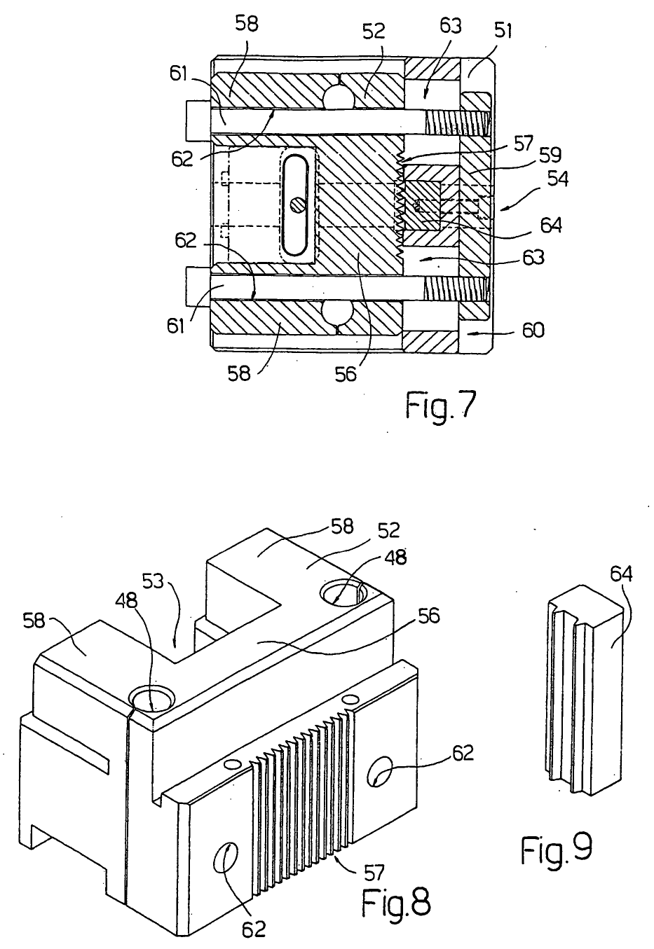

With reference to FIGS. 4 and 5, anvil assembly 24 comprises an anvil-holder assembly 46, which has an L-shaped support 51 integral with slide 23, and a pocket 52 for housing anvil 33. Pocket 52 comprises a seat 53 for housing anvil 33, and is fitted to support 51 by a fastening device 54 permitting adjustment of the position of anvil 33 in direction D3. As shown in FIGS. 5 and 8, pocket 52 comprises a bottom wall 55; a rear wall 56 having a central portion with vertical grooves 57; and two lateral walls 58. With reference to FIG. 7, fastening device 54 comprises a bar 59 connected to pocket 52 and housed to slide in direction D3 inside a groove 60 in support 51; and two screws 61 screwed to bar 59 and extending through respective holes 62 in lateral walls 58 of pocket 52, and through respective slots 63 in support 51. Fastening device 54 also comprises a splined member 64 (FIG. 9), which is fixed to support 51, is interposed between slots 63, and has two longitudinal projections for engaging corresponding grooves 57 in rear wall 56. Groove 60 and slots 63 are parallel to direction D3, and, once screws 61 are loosened, provide for moving pocket 52 with respect to support 51, and for adjusting the position of anvil 33 with respect to head 40. The splined connection of rear wall 56 of pocket 52 and member 64 defines a precise position of pocket 52 with respect to support 51, and ensures precise engagement of holes 62 by respective screws 61.

With reference to FIGS. 4 and 5, anvil 33 comprises a top portion 65, in which seat 32 for housing connector 2 is formed; and a bottom portion 66, which defines a support for top portion 65 with the interposition of two springs 67, and partly engages top portion 65. Bottom portion 66 is provided on top with projections 34, which project through top portion 65 and support respective blades 12 in use. Anvil 33 is housed inside seat 53 of pocket 52, and is fitted to pocket 52 by screws 68.

Crimping unit 1 comprises an ejector 69 for removing connector 2, crimped to a respective cable 3, from seat 32 by upward force in direction D2. Ejector 69 is defined by three separate members extending successively in direction D2 and maintained contacting one another by elastic means, so that operation of the bottom member is transmitted to the other two.

More specifically, ejector 69 comprises an actuator 70 fitted to frame 22; a first push rod 71 fitted to slide 23; and a second push rod 72 fitted to pocket 52. Actuator 70 is located beneath anvil assembly 24, between columns 30, and is movable in direction D2 between a lowered rest position (FIGS. 4 and 5) and a raised operating position (not shown).

Push rod 71 is T-shaped, is housed in a seat 73 on slide 23, is movable in direction D2 between a lowered rest position (FIGS. 4 and 5) and a raised operating position (not shown), and has a top surface 74 which contacts push rod 72, and a bottom surface 75 which cooperates with actuator 70. Top surface 74 is formed on the head of the T, and is substantially larger than the bottom surface in direction D3. Push rod 71 is maintained in the rest position by two springs 76.

Push rod 72 is in the form of a straightforward rod, is housed in bottom wall 55 of pocket 52, and is movable between a lowered rest position (FIGS. 4 and 5) and a raised operating position (not shown). Push rod 72 is maintained in the rest position by a spring 77 associated with bottom wall 55, and extends through a hole 78 formed in bottom portion 66 of anvil 33, and through a slot 79 formed in support 51 and extending parallel to direction D3 by a distance greater than top surface 74 of push rod 71. Push rod 72 has a top surface 80 which contacts and expels a connector 2 from seat 32; and a bottom surface 81 which cooperates with top surface 74 of push rod 71.

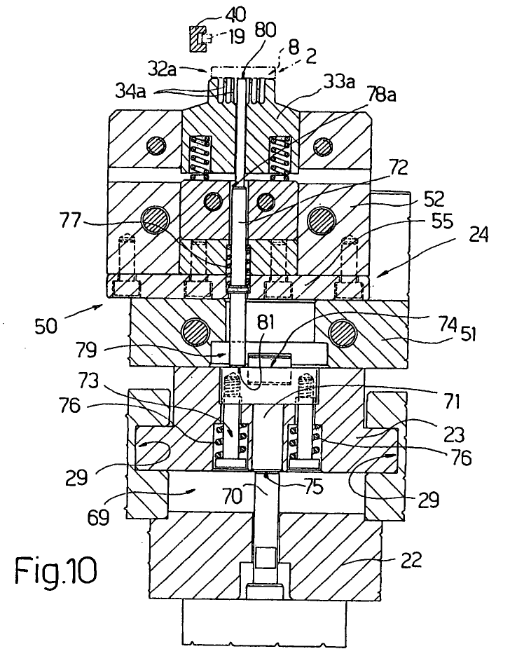

With reference to FIG. 10, 33a indicates an anvil having a seat 32a smaller than seat 32 and for housing small connectors 2. Except for the size of seat 32a and the overall size of projections 34a, anvil 33a is the same shape and size as anvil 33, and has a central hole 78a for housing push rod 72. Pocket 52 is fixed to support 51 in a position closer to head 40 than in the case of anvil 33, so as to position seat 32a beneath head 40 and permit insertion of the cover inside seat 41. In this position, push rod 72 is not aligned with actuator 70, but is located directly over top surface 74 of push rod 71, with no interruption in the transmission chain between actuator 70 and push rod 72.

In actual use, and with reference to FIG. 1, anvil assembly 24 is positioned at the rear end of frame 22, at a loading station 82, where anvil assembly 24 is not aligned with pressure assembly 26, so as to facilitate insertion of casing 8 of connector 2 inside seat 32, and cover 9 inside seat 41.

Once connector 2 is positioned inside seats 32 and 41, anvil assembly 24 is moved back by drive member 28 to the FIG. 1 position, i.e. to a crimping station 83, where anvil assembly 24 is aligned beneath pressure assembly 26.

Push rods 71 and 72, associated with slide 23 and pocket 52 respectively, are moved back and forth between station 82 and station 83, where actuator 70 and push rod 71 are substantially aligned in direction D2.

As shown in FIG. 3, connector 2 is positioned inside seat 32 with cover 9 raised and partly engaging head 40 of device 27. At crimping station 83, end portion 7 of cable 3 is inserted inside seat 32, on top of blades 12 and between crosspieces 17 and 20, and pressure assembly 26 is lowered in direction D2 along columns 30 towards anvil assembly 24. As pressure assembly 26 moves towards anvil assembly 24, the following operations are performed successively: vertical rods 47 engage holes 48 in anvil assembly 24; device 27 is pushed into the release position (not shown) to release cover 9; pusher 45 intercepts crosspiece 20 of cover 9 and pushes cover 9 into the closed position in which projections 21 engage the respective seats (not shown) in arms 16 to click cover 9 onto casing 8; member 44 intercepts and pushes the end portion of strip 6 against pointed tabs 15 of blades 12 resting on anvil 33, so that tabs 15 pierce strip 6 and tracks 5; and member 44 presses tabs 15 against anvil 33 to fold tabs 15 outwards of respective holes 14, i.e. perform the crimping operation. When crimping blades 12 to tracks 5, head 49 of pusher 45 overcomes spring 50 and moves in the opposite direction to that of pressure assembly 26. Once the connection is made, pressure assembly 26 is raised; actuator 70 is moved into the operating position partly occupying seat 73 in the slide, and pushes push rod 71 upwards; and push rod 71 in turn pushes push rod 72 upwards through seat 32 to expel connector 2.

With reference to FIG. 10, anvil 33 is replaced by anvil 33a, which, once positioned in direction D3, performs the same operations described above. In other words, ejector 69 comprises three movable members connected by a transmission chain which is maintained even when the position of anvil 33a is changed in direction D3.

In a variation not shown, the flat electric cable comprises two opposite, facing strips enclosing a number of parallel conducting tracks located a given distance apart. Such flat electric cables, however, in no way affect crimping unit 1 or the crimping method.

1) A crimping unit for joining electric connectors (2) to flat electric cables (3); each said connector (2) comprising an insulating casing (8) and a number of electric terminals (4) supported by said casing (8); each said flat electric cable (3) comprising a number of conducting tracks (5) arranged along an insulating strip (6); and the crimping unit being characterized by comprising an anvil assembly (24) having an anvil (33; 33a) having a first seat (32; 32a) for housing said casing (8) of said connector (2); a pressure assembly (26) cooperating with said anvil assembly (24) to crimp said electric terminals (4) to respective said conducting tracks (5); and an ejector (69) having a first push rod (72) housed in said anvil assembly (24) to expel said casing (8) from said first seat (32; 32a).

2) A unit as claimed in claim 1, wherein said anvil assembly (24) comprises a pocket (52) for housing anvils (33; 33a) having respective first seats (32; 32a) sized as a function of the dimensions of relative casings (8) of said connectors (2); said first push rod (72) being fitted to said pocket (52).

3) A unit as claimed in claim 2, wherein each said anvil (33; 33a) comprises a hole (78; 78a) for housing said first push rod (72).

4) A unit as claimed in any one of claims 1 to 3, wherein said first push rod (72) is movable between a rest position housed inside the relative said anvil (33; 33a), and an operating position projecting from said anvil (33; 33a) at said first seat (32; 32a).

5) A unit as claimed in claim 4, wherein said first push rod (72) is maintained in the rest position by first elastic means (77) supported by said pocket (52).

6) A unit as claimed in any one of claims 2 to 5, and comprising a control device (27) for controlling the position of a cover (9) of said connector (2) hinged to said casing (8); said control device (27) being fitted to said anvil assembly (24) and comprising a head (40) having a second seat (41) for housing the cover (9) of said connector (2); the position of said anvil (33; 33a) and of said first push rod (72) being adjustable with respect to said head (40).

7) A unit as claimed in claim 6, wherein said anvil assembly (24) comprises a support (51) for supporting said pocket (52); and a fastening device (54) for locking said pocket (52) in a number of given positions with respect to said support (51) and said head (40).

8) A unit as claimed in any one of the foregoing claims, wherein said anvil assembly (24) is mounted on a slide (23) movable, in a first direction (D1), between a loading station (82) for loading said connectors (2), and a crimping station (83) where said anvil assembly (24) is aligned with said pressure assembly (26) in a second direction (D2) perpendicular to said first direction (D1).

9) A unit as claimed in claim 8, wherein said anvil (33; 33a) and said first push rod (72) are movable in a third direction (D3), perpendicular to said second direction (D2), to adjust the position of said first seat (32; 32a) with respect to said anvil assembly (24).

10) A unit as claimed in claim 9, wherein said third direction (D3) is perpendicular to said first direction (D1).

11) A unit as claimed in one of claims 8 to 10, wherein the ejector (69) comprises a second push rod (71) supported by said slide (23); said second push rod (71) being movable, in said second direction (D2), between an operating position, in which it pushes said first push rod (72) into the respective said operating position, and a rest position.

12) A unit as claimed in claim 11, wherein said slide (23) comprises second elastic means (76) for maintaining said second push rod (71) in said rest position.

13) A unit as claimed in claim 11 or 12, wherein said second push rod (71) comprises a top surface (74) contacting said first push rod (72), and a bottom surface (75); said top surface (74) extending in said third direction (D3) to a greater extent than said bottom surface (75).

14) A unit as claimed in any one of claims 11 to 13, and comprising a supporting frame (22); the ejector (69) comprising an actuator (70) carried by said frame (22) and for pushing said second push rod (71) into said operating position.

15) A unit as claimed in claim 1, and comprising a frame (22); the ejector (69) comprising an actuator (70) integral with said frame (22) and performing an expulsion stroke; and said first push rod (72) defining a transmission chain with said actuator (70), and being movable crosswise with respect to the stroke of said actuator (70).

16) A unit as claimed in claim 15, wherein said ejector comprises a second push rod (71) insertable between said first push rod (72) and said actuator to link said first push rod (72) and said actuator (70).
